(19) United States
(12) Patent Application Publication
(10) Pub. No.: US 2009/0210741 A1
(43) Pub. Date: Aug. 20, 2009

(54) INFORMATION PROCESSING APPARATUS AND INFORMATION PROCESSING METHOD

(75) Inventor: Nobuyoshi YAMAOKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/370,034

(22) Filed: Feb. 12, 2009

(30) Foreign Application Priority Data
Feb. 18, 2008 (JP) 2008-036037

(51) Int. Cl. G06F 1/00

(52) U.S. Cl. 713/600

(57) ABSTRACT

An information processing apparatus includes a predicting unit to predict temperature of the apparatus when allowing one or more processing units mounted in the apparatus to execute a new program, a temperature determining unit to compare the predicted temperature with a predetermined reference value, a priority determining unit to compare priorities of the new program and an active program in execution if the temperature is equal to or greater than the predetermined reference value, and an operation clock setting unit to set an operation clock to the one or more processing units, the operation clock enabling the predicted temperature to less than the predetermined reference value even if one of the processing units is allowed to execute the new program, and to allow the one or more processing units to execute the new program if the priority of the new program is higher than the priority of the active program.

### CROSS-REFERENCE TO RELATED APPLICATIONS

This application is based upon and claims the benefit of priority from the prior Japanese Patent Application No. 2008-36037 filed on Feb. 18, 2008, the entire contents of which are incorporated herein by reference.

### BACKGROUND

When a CPU (Central Processing Unit) of an information processing apparatus operates at full power, power consumption of the CPU is high and the temperature inside the information processing apparatus rises accordingly. For example, in the case where the information processing apparatus is placed in a data center and where the CPU thereof constantly operates at full power, the exhaust temperature of the information processing apparatus causes the temperature inside the data center to exceed an allowable temperature.

Also, in the case where numerical simulation involving advanced calculation (e.g., a parallel calculation process such as CAE numerical simulation) is performed for a long time, submission of a calculating job (program) causes a heat generation load of the CPU of the information processing apparatus, so that the temperature of the CPU and its surroundings rises. If a high-temperature state continues, stable operation of the information processing apparatus is difficult to maintain.

According to a method that has conventionally been used, a temperature sensor in an information processing apparatus detects a rise in temperature, air volume increases as the number of rotations of fans (intake and exhaust fans) in the information processing apparatus increases, and the increase in air volume suppresses a rise in temperature inside the information processing apparatus.

In an information processing apparatus including a plurality of fans as illustrated in FIG. 1, when a waiting job exists in a job controller that performs control to assign jobs to be submitted in response to instructions from respective clients to CPUs (i.e. when all the CPUs in the information processing apparatus operate at full power), fans in a standby state are operated to increase intake air volume and exhaust air volume. Accordingly, a rise in temperature inside the information processing apparatus is suppressed.

As a related art, there is disclosed a low-power-consumption circuit that realizes a method for minimizing total power consumption at a processing operation while maintaining maximum performance of a system (e.g., Patent Document 1: Japanese Laid-open Patent Publication No. H06-309288). Also, there are disclosed a method and an apparatus to reduce energy consumed by a processor (e.g., Patent Document 2: Japanese Laid-open Patent Publication No. 2005-267635).

However, enhancement of the ability of fans or an air-conditioning device for promoting a cooling ability involves power consumption in accordance with the enhancement. In some information processing apparatuses, the cooling ability of an air-conditioning device such as fans is insufficient for the total heat value of the information processing apparatus. In such an information processing apparatus, temperature adjustment is difficult to be done, which affects a stable operation of the apparatus.

The present invention has been made in order to solve the above-described problems, and an object of the present invention is to provide an information processing apparatus and an information processing method, capable of minimizing an increase in heat value by predicting the temperature inside the information processing apparatus.

### SUMMARY

Various embodiments of the present invention provide an information processing apparatus including a predicting unit configured to predict a temperature of the information processing apparatus when allowing one or more processing units mounted in the information processing apparatus to execute a new program, a temperature determining unit configured to compare the predicted temperature with a predetermined reference value, a priority determining unit configured to compare priorities of the new program and an active program in execution if the temperature is equal to or greater than the predetermined reference value, and an operation clock setting unit configured to set an operation clock to the one or more processing units, the operation clock enabling the predicted temperature to less than the predetermined reference value even if one of the processing units is allowed to execute the new program, and to allow the one or more processing units to execute the new program if the priority of the new program is higher than the priority of the active program.

Various embodiments of the present invention provide an information processing method allowing a computer to execute predicting a temperature of an information processing apparatus when allowing one or more processing units mounted in the information processing apparatus to execute a new program, comparing the predicted temperature with a predetermined reference value, comparing priorities of the new program and an active program in execution if the predicted temperature is equal to or greater than the predetermined reference value, and setting an operation clock to the one or more processing units, the operation clock enabling the predicted temperature to be less than the predetermined reference value even if one of the processing units is allowed to execute the new program, and allowing the one or more processing units to execute the new program if the priority of the new program is higher than the priority of the active program.

### BRIEF DESCRIPTION OF THE DRAWINGS

FIG. 1 illustrates temperature control (control by a plurality of fans) in a conventional information processing apparatus.

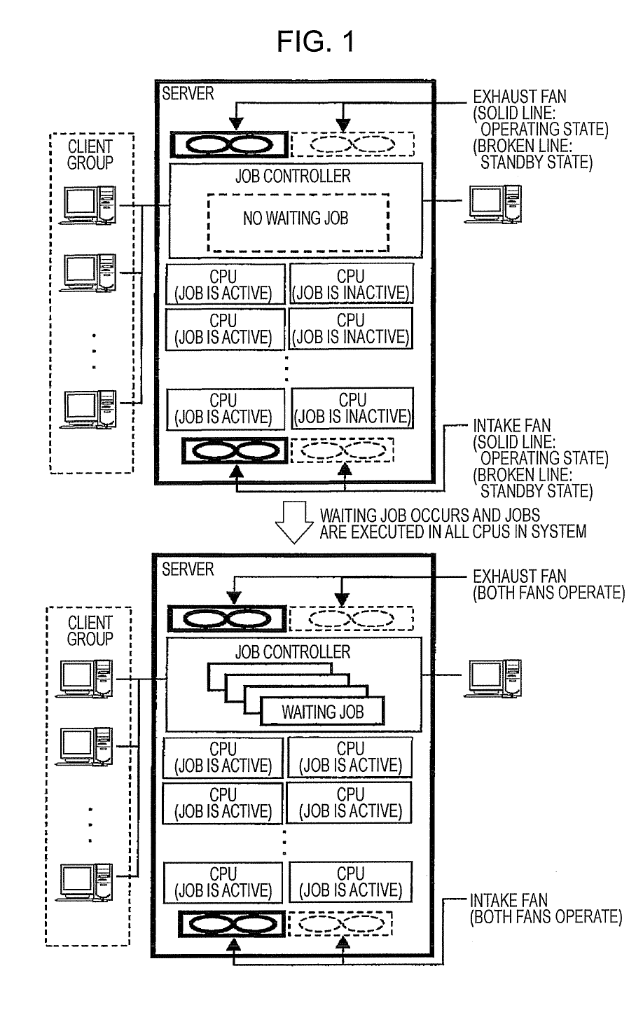

FIG. 2 illustrates an example of a configuration of an information processing apparatus according an embodiment.

FIG. 3 illustrates an example of functional blocks of the information processing apparatus according to an embodiment.

FIG. 4 is a flowchart illustrating an example of a process performed by the information processing apparatus according to an embodiment (comparison based on priority).

FIG. 5 is a flowchart illustrating an example of the process performed by the information processing apparatus according to an embodiment (determination of multistage priority).

FIG. 6 illustrates a cross section of the information processing apparatus according to an embodiment.

### DETAILED DESCRIPTION OF THE EMBODIMENTS

Hereinafter, an information processing apparatus and an information processing method according to an embodiment are described with reference to the drawings. This embodiment is an embodiment of the present invention, and the present invention is not limited to this embodiment.

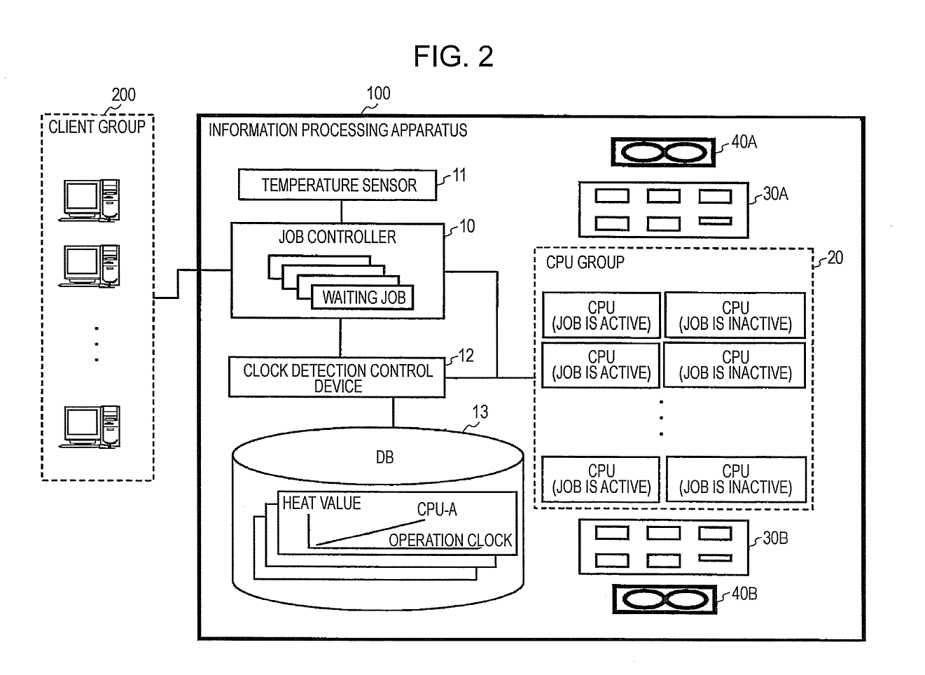

A configuration of an information processing apparatus is described with reference to FIG. 2.

The information processing apparatus 100 includes a CPU group 20 having grouped one or more CPUs (CPU: Central Processing Unit) (processing unit); and memory modules 30A and 30B serving as a volatile storage device. Also, the information processing apparatus 100 includes an intake fan 40B to take air into the information processing apparatus 100 and an exhaust fan 40A to discharge air in the information processing apparatus 100.

Furthermore, the information processing apparatus 100 includes a job controller 10, a temperature sensor 11, a clock detection control device 12, and a DB 13 (DB: DataBase).

The job controller 10 performs management of determining jobs (programs) that are submitted and executed in the respective CPUs. Also, when receiving instructions to submit a job from a client group 200, the job controller 10 determines the CPU to which the job is to be assigned and controls submission of the job. The job controller 10 according to this embodiment is a board provided with a volatile memory, a nonvolatile memory, and a CPU. Alternatively, part of the CPUs in the CPU group 20, the memory modules 30A and 30B, and a nonvolatile memory (not illustrated) included in the information processing apparatus 100 may function as the job controller 10.

The temperature sensor 11 monitors the intake temperature (temperature at the vicinity of the intake fan 40B) and the exhaust temperature (temperature at the vicinity of the exhaust fan 40A) of the information processing apparatus 100. The clock detection control device 12 detects current operation clocks of the respective CPUs and performs control so that the respective CPUs operate at predetermined operation clocks.

The DB 13 holds correspondence tables for the respective CPUs, each table showing the correspondence between operation clock and heat value of the CPU. Furthermore, the DB 13 holds a correspondence table showing the correspondence between exhaust temperature and the amount of decrease in clock.

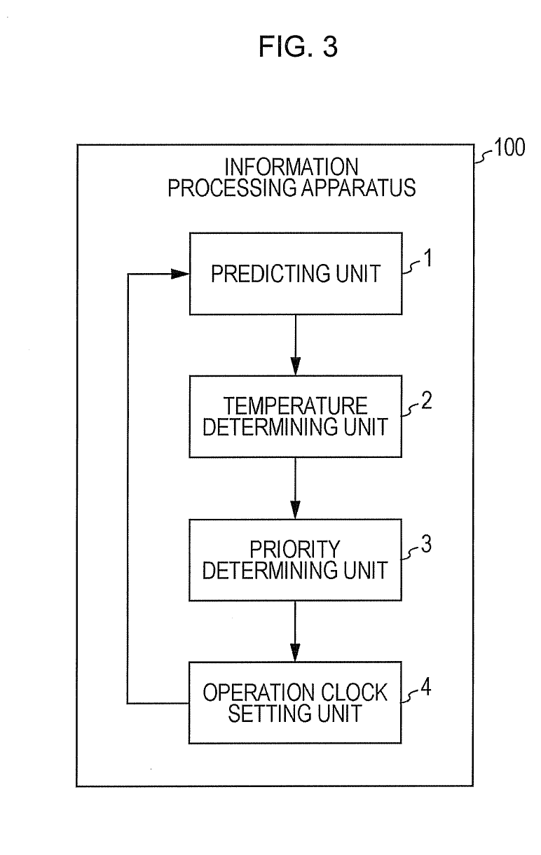

FIG. 3 illustrates functional blocks of the information processing apparatus 100 according to an embodiment.

The information processing apparatus 100 includes a predicting unit 1, a temperature determining unit 2, a priority determining unit 3, and an operation clock setting unit 4.

The predicting unit 1 predicts the exhaust temperature of the information processing apparatus 100 in the case where a program newly submitted to one or plural CPUs provided in the information processing apparatus 100 is executed.

The temperature determining unit 2 compares the predicted exhaust temperature with a reference value. The reference value is 60° C. in this embodiment, but the value is not limited. The priority determining unit 3 compares and determines the priority of the above-described program to be newly submitted if the temperature determining unit 2 determines that the predicted exhaust temperature is equal to or higher than the reference value.

The operation clock setting unit 4 sets an operation clock to each of the CPUs (or the entire CPU group 20) so that the predicted exhaust temperature is lower than the reference value even if the newly submitted program is executed on the basis of the comparison/determination result made by the priority determining unit 3, and allows any of the CPUs to execute the new program.

Also, the operation clock setting unit 4 sequentially decreases the operation clock of the CPUs so that the exhaust temperature predicted by the predicting unit 1 is lower than the reference value. Also, the operation clock setting unit 4 determines the operation clock of each of the CPUs (or the entire CPU group 20) on the basis of the exhaust temperature predicted by the predicting unit 1.

Furthermore, after execution of a newly submitted program or an active program has ended, the operation clock setting unit 4 changes the operation clock back to the operation clock before submission (predetermined operation clock).

The function of the predicting unit 1 is realized by the job controller 10, the temperature sensor 11, the clock detection control device 12, and the DB 13. The functions of the temperature determining unit 2 and the priority determining unit 3 are realized by the job controller 10. Furthermore, the function of the operation clock setting unit 4 is realized by the job controller 10, the clock detection control device 12, and the DB 13. Processes of the respective functions are realized when the CPU mounted on the above-described board of the job controller 10 executes firmware stored in the nonvolatile memory mounted on the board.

Now, an outline of a process performed by the information processing apparatus 100 according to this embodiment is described. The information processing apparatus 100 determines whether the exhaust temperature is lower than the reference value before submission of a job. If the exhaust temperature is lower than the reference value, a job is submitted. If the exhaust temperature is equal to or higher than the reference value, submission of a job is stopped (temporarily postponed). Also, if there is a job that is to be executed (high-priority job) among jobs that are to be stopped, the information processing apparatus 100 controls the operation clock of the CPUs so that the exhaust temperature is lower than the reference value and allows the high-priority job to be executed.

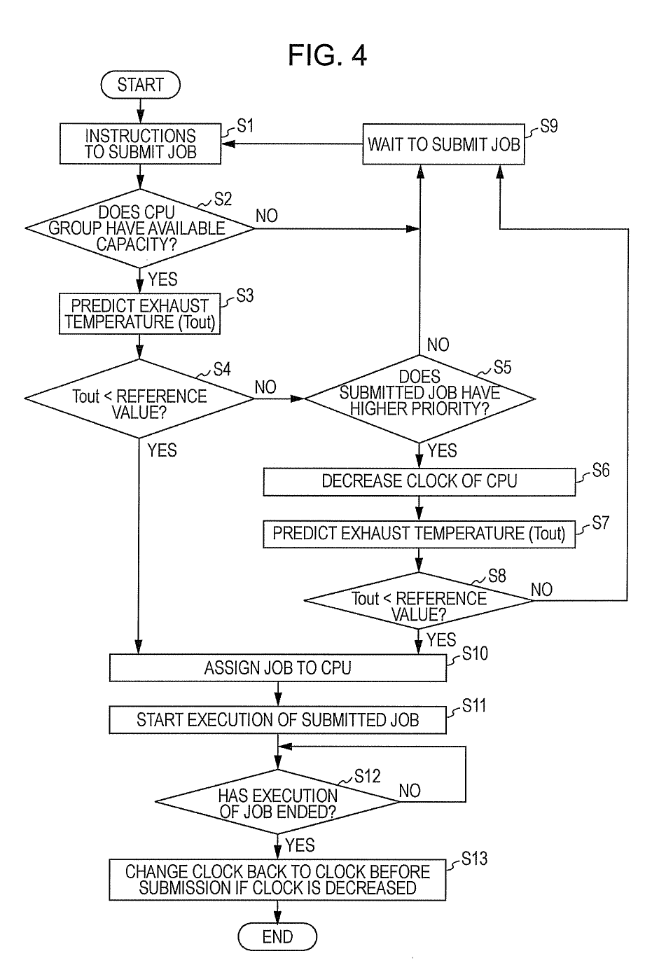

Next, a process performed by the information processing apparatus 100 when a new job is submitted according to this embodiment is described with reference to the flowchart in FIG. 4.

First, the job controller 10 receives instructions to submit a new job from the client group 200 (S1), and determines whether there is a CPU having available capacity (e.g., having an operation rate of less than 80%) in the CPU group 20 (S2). If the CPU group 20 has no available capacity (NO in S2), submission of the job is postponed (S9). If the CPU group 20 has available capacity (YES in S2), the predicting unit 1 predicts the exhaust temperature (Tout) at the time on the basis of the method described below (S3). In S3, an actual measurement value of the exhaust temperature detected by the temperature sensor 11 may be obtained without predicting the exhaust temperature.

The temperature determining unit 2 compares the predicted exhaust temperature with the reference value (S4). If the exhaust temperature is lower than the reference value (YES in S4), the job controller 10 assigns the submitted job to the CPU having available capacity (S10), and then execution of the job starts (S11).

On the other hand, if the temperature determining unit 2 determines that the predicted exhaust temperature is equal to or higher than the reference value (NO in S4), the priority determining unit 3 compares the priority of the newly submitted job with the priority of the job that is currently in execution (S5). The priorities of respective jobs are individually defined by a user at or before submission of the jobs.

If the priority of the newly submitted job is lower than or the same as the priority of the job that is currently in execution (NO in S5), submission of the job is postponed (S9). On the other hand, if the priority of the newly submitted job is higher than the priority of the job that is currently in execution (YES in S5), the operation clock setting unit 4 decreases the current operation clock of the CPU to which the submitted job is to be assigned or the entire CPU group 20 (S6).

The operation clock setting unit 4 allows the DB 13 to hold the correspondence table showing the correspondence between exhaust temperature and the amount of decrease in clock, calculates the amount of decrease in clock by using the currently predicted exhaust temperature and the correspondence table, and subtracts the amount of decrease in clock from the current operation clock, so as to determine the operation clock used for a next operation. Alternatively, the operation clock setting unit 4 may decrease the clock by a predetermined percentage (e.g., 20%) of the current operation clock.

The predicting unit 1 further predicts the exhaust temperature after the decrease in clock (S7). If the predicted exhaust temperature is lower than the reference value (YES in S8), the job controller 10 assigns the job to the CPU (S10), and execution of the job starts (S11). On the other hand, if the predicted exhaust temperature is equal to or higher than the reference value (NO in S8), submission of the job is postponed (S9).

After execution of the job has started (S11) and after the newly executed job or the job that has been executed ends (YES in S12), the operation clock setting unit 4 changes the operation clock of the CPU (or the entire CPU group 20) back to the operation clock before submission of the job if the clock of the CPU is decreased in S6 as described above (S13).

The job controller 10 submits the job postponed in S9 again (S1) at a predetermined time interval (e.g., one minute). If the job controller 10 determines that there is a CPU having available capacity in accordance with an assignment state of jobs managed by the job controller 10 in S9 (e.g., determines whether an job in execution has ended), the job controller 10 may submit the job again (S1).

If the predicted exhaust temperature is equal to or higher than the predetermined value (NO in S8), the process may return to S6, not to S9. Accordingly, the operation clock can be sequentially decreased so that the exhaust temperature is lower than the reference value.

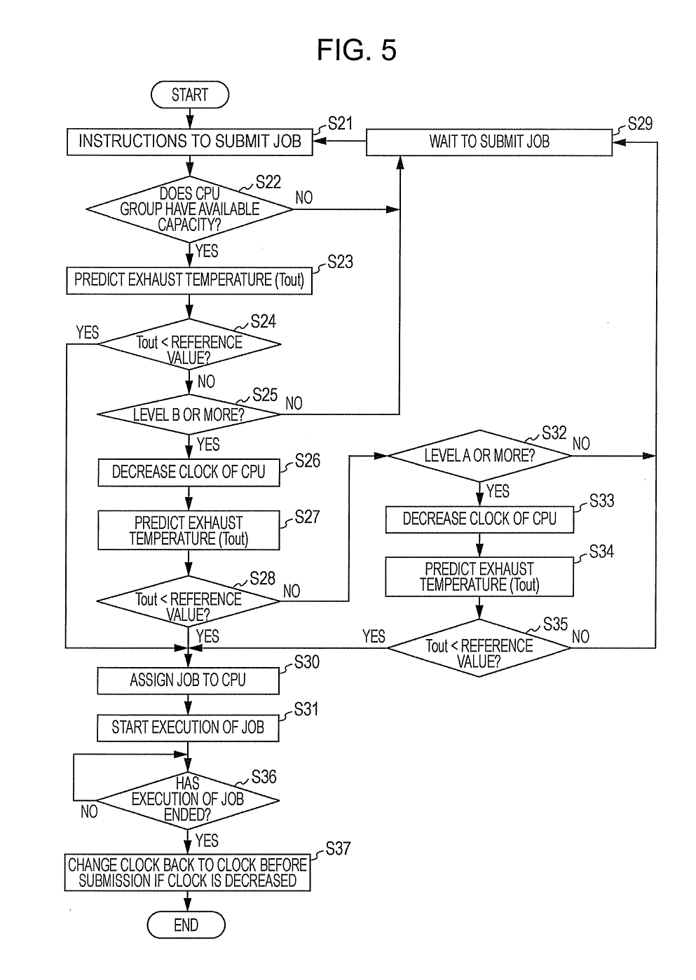

In the above-described flowchart, the priority determining unit 3 compares the priority of a newly submitted job with the priority of a job currently in execution. Hereinafter, a process performed in the case where multistage priority is set is described with reference to the flowchart in FIG. 5. In the flowchart in FIG. 5, three stages of priority, that is, levels A, B, and C are set. Level A corresponds to the highest priority, whereas level C corresponds to the lowest priority. However, the number of levels is not limited.

In FIG. 5, S21 to S24 correspond to S1 to S4 in FIG. 4, respectively, and thus the description thereof is omitted.

In S24, if the predicted exhaust temperature is equal to or higher than the reference value (NO in S24), the priority determining unit 3 determines the priority (S25). If the priority of the newly submitted job is lower than level B (i.e., level C) (NO in S25), submission of the job is postponed (S29).

On the other hand, if the priority of the newly submitted job has level B or more (YES in S25), the operation clock setting unit 4 decreases the current clock of the CPU (S26). Then, the predicting unit 1 predicts the exhaust temperature (Tout) of the system on the basis of the heat value of the operation clock at the time (S27).

If the temperature determining unit 2 determines that the predicted exhaust temperature is lower than the reference value (YES in S28), the job controller 10 assigns the job to the CPU (S30), and execution of the job starts (S31).

On the other hand, if the temperature determining unit 2 determines that the predicted exhaust temperature is equal to or higher than the reference value (NO in S28), the priority determining unit 3 determines the priority (S32). If the priority of the newly submitted job is lower than level A (i.e., level B) (NO in S32), submission of the job is postponed (S29).

On the other hand, if the priority of the newly submitted job has level A or more (i.e., level A) (YES in S32), the operation clock setting unit 4 decreases the current clock of the CPU (S33) as described above and the predicting unit 1 predicts the exhaust temperature (Tout) of the system on the basis of the heat value of the operation clock at the time (S34).

If the temperature determining unit 2 determines that the predicted exhaust temperature is lower than the reference value (YES in S35), the job controller 10 assigns the job to the CPU (S30), and execution of the job starts (S31). On the other hand, if the temperature determining unit 2 determines that the predicted exhaust temperature is equal to or higher than the reference value (NO in S35), submission of the job is postponed (S29).

S36 and S37 are the same as S12 and S13 described above, and thus the description thereof is omitted.

Also, in the case where four or more levels of priority are set, the information processing apparatus 100 can perform the process of S32 to S35 in accordance with the level of priority if the determination in S25 is NO.

In this way, the information processing apparatus 100 can sequentially decrease the clock of the CPU in accordance with the level of priority even if multistage priority is set, so as to determine assignment of the CPUs.

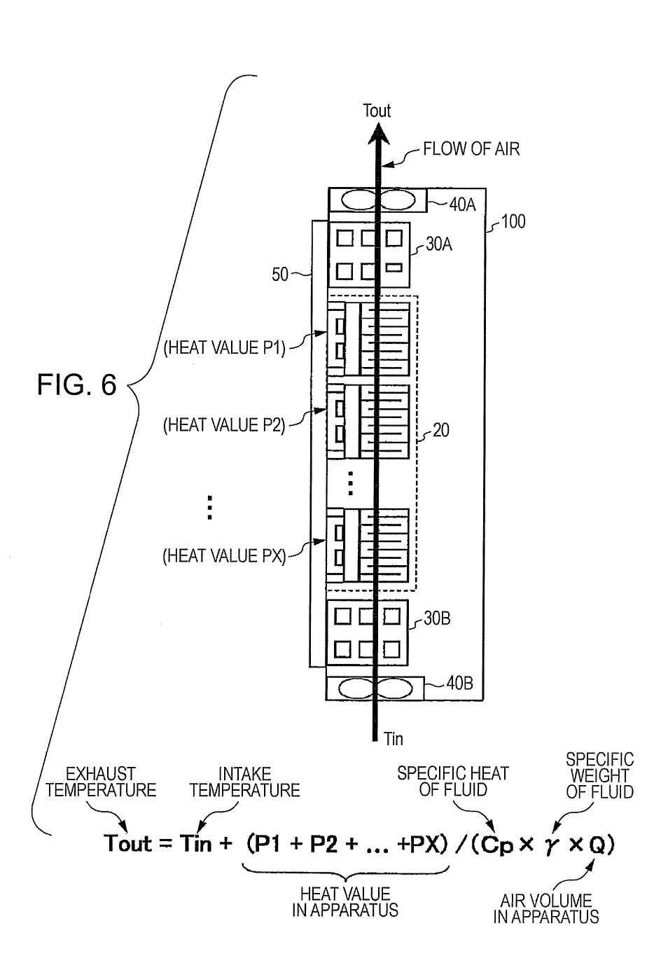

Next, a method for calculating (predicting) the exhaust temperature by the predicting unit 1 is described with reference to the cross-sectional view of the information processing apparatus 100 illustrated in FIG. 6.

In the information processing apparatus 100, the intake fan 40B is placed on one side of the casing thereof and the exhaust fan 40A is placed on the other side, as illustrated in FIG. 6. The air in the information processing apparatus 100 flows from the intake fan 40B toward the exhaust fan 40A. Also, as illustrated in FIG. 6, the memory module 30B, the CPU group 20, and the memory module 30A are placed on a system board 50, in that order, from the upstream of air.

Also, as described above, the DB 13 holds the correspondence tables for the respective CPUs in the CPU group 20, each table showing the correspondence between operation clock and heat value. The predicting unit 1 can obtain heat values of the respective CPUs on the basis of the respective current operation clocks of the CPUs by using the correspondence tables.

On the basis of the heat values obtained in the above-described manner, the exhaust temperature is calculated and predicted in the following way.

Tout=Tin+(P1+P2+ . . . +PX)/(Cp·γ·Q)

In this expression, Tout is a predicted exhaust temperature; Tin is an intake temperature (intake temperature detected by the temperature sensor 11 at the timing of prediction); P1, P2, . . . , and PX are heat values of the respective CPUs (the total sum of P1, P2, . . . , and PX is regarded as a heat value in the apparatus); Q is air volume in the apparatus (fixed value predefined on the basis of the performance of the exhaust and inlet fans); Cp is specific heat of fluid; and γ is specific weight of fluid.

If the predicting unit 1 can obtain current heat values of respective elements included in the casing of the information processing apparatus 100 (the memory modules 30A and 30B and a hard disk drive (not illustrated) in addition to the CPUs), the predicting unit 1 may add the current heat values as part of the heat value in the apparatus.

The DB 13 may hold correspondence tables for operation clocks of the entire CPU group 20, each table showing the correspondence between an executed job and a heat value generated when the job is executed, so that the predicting unit 1 may obtain the heat value of the entire CPU group 20 on the basis of the current operation clock of the entire CPU group 20 and a submitted job and may substitute the obtained heat value into the above expression. In this way, the predicting unit 1 can predict the exhaust temperature of the information processing apparatus 100 when a job is newly executed.

Furthermore, although the amount of held data increases, the DB 13 may hold correspondence tables for the respective CPUs in the CPU group 20 and operation clocks of the CPUs, each table showing the correspondence between an executed job and a heat value when the job is executed, so that the predicting unit 1 may obtain heat values of the respective CPUs on the basis of current operation clocks of the CPUs and a submitted job and may substitute the obtained heat values into the above expression.

In this embodiment, the exhaust temperature, which is estimated to be particularly high in the information processing apparatus 100, is predicted. However, any temperature in the information processing apparatus 100 may be predicted.

According to this embodiment, submission of a job and an operation clock of a CPU can be controlled on the basis of the priority of the job. Therefore, even if there is no choice but to operate an information processing apparatus in a high-temperature data center, a stable temperature condition can be realized and a system operation can be stabilized.

The information processing method described can be implemented by executing a prepared program by a computer such as a personal computer or a workstation. This program is executed by being recorded on a computer-readable recording medium such as a hard disk, a flexible disk, a CD-ROM, an MO, or a DVD and being read from the recording medium by the computer. This program may be a transmission medium capable of being distributed through a network such as the Internet.

The present invention has been described with respect to one or more specific embodiments. However, it is to be understood that the invention is not limited to the specific embodiments, and many modifications to the embodiments are possible within the scope of the invention, which is defined in the appended claims.

1. An information processing apparatus comprising:
a predicting unit configured to predict a temperature of the information processing apparatus when allowing one or more processing units mounted in the information processing apparatus to execute a new program;
a temperature determining unit configured to compare the predicted temperature with a predetermined reference value;
a priority determining unit configured to compare priorities of the new program and an active program in execution if the temperature is equal to or greater than the predetermined reference value; and
an operation clock setting unit configured to set an operation clock to the one or more processing units, the operation clock enabling the predicted temperature to less than the predetermined reference value even if one of the processing units is allowed to execute the new program, and to allow the one or more processing units to execute the new program if the priority of the new program is higher than the priority of the active program.

2. The information processing apparatus according to claim 1, wherein the operation clock setting unit sequentially decreases the operation clock of the one or more processing units so that the predicted temperature is under the predetermined reference value.

3. The information processing apparatus according to claim 1, wherein the operation clock setting unit determines the operation clock based on the temperature predicted by the predicting unit.

4. The information processing apparatus according to claim 1, wherein the operation clock setting unit changes the operation clock back to a predetermined operation clock after execution of the new program or the active program has ended.

5. The information processing apparatus according to claim 2, wherein the operation clock setting unit changes the operation clock back to a predetermined operation clock after execution of the new program or the active program has ended.

6. The information processing apparatus according to claim 3, wherein the operation clock setting unit changes the operation clock back to a predetermined operation clock after execution of the new program or the active program has ended.

7. The information processing apparatus according to claim 1, wherein the predicting unit predicts the temperature based on correspondence between a program that is executed and a heat value generated when the program is executed.

8. The information processing apparatus according to claim 1, wherein the predicting unit predicts the temperature based on correspondence between a program that is executed and a heat value generated when the program is executed.

9. The information processing apparatus according to claim 2, wherein the predicting unit predicts the temperature based on correspondence between a program that is executed and a heat value generated when the program is executed.

10. The information processing apparatus according to claim 3, wherein the predicting unit predicts the temperature based on correspondence between a program that is executed and a heat value generated when the program is executed.

11. The information processing apparatus according to claim 4, wherein the predicting unit predicts the temperature based on correspondence between a program that is executed and a heat value generated when the program is executed.

12. An information processing method allowing a computer to execute:
predicting a temperature of an information processing apparatus when allowing one or more processing units mounted in the information processing apparatus to execute a new program;
comparing the predicted temperature with a predetermined reference value;
comparing priorities of the new program and an active program in execution if the predicted temperature is equal to or greater than the predetermined reference value; and
setting an operation clock to the one or more processing units, the operation clock enabling the predicted temperature to be less than the predetermined reference value even if one of the processing units is allowed to execute the new program, and allowing the one or more processing units to execute the new program if the priority of the new program is higher than the priority of the active program.
